(19) United States
(12) Patent Application Publication
(10) Pub. No.: US 2025/0216697 A1
(43) Pub. Date: Jul. 3, 2025

(54) Glasses With Eyeball Rounding Muscle Exercising Strip

(71) Applicant: Brian Michael Doucet, Dixon, IL (US)

(72) Inventor: Brian Michael Doucet, Dixon, IL (US)

(21) Appl. No.: 18/937,058

(22) Filed: Nov. 5, 2024

Related U.S. Application Data
(60) Provisional application No. 63/615,285, filed on Dec. 28, 2023.

(51) Int. Cl. G02C 7/02; G02C 7/10

(52) U.S. Cl. CPC G02C 7/021; G02C 7/104; G02C 2202/06

(57) ABSTRACT

Many People around the world suffer from bad vision being nearsighted or farsighted. Many others suffer from glaucoma which is the second leading cause of blindness in the world. These conditions are treated in various ways; however, they are generally considered irreversible. In many cases all of these symptoms come down to muscle strength and tension pulling around the eyeball. Nearsightedness is simply caused by looking up and down more than left and right with the eyeball. Farsightedness is simply caused by looking left and right more than up and down with the eyeball. And if the muscles are too strong all around the eyeball, this can exert excess pressure around the eyeball causing in some cases the symptoms of glaucoma. By wearing this invented apparatus, a wearer can be naturally encouraged to correct posture. This can strengthen or weaken muscle groups around the eyeball to create even tension to pull the eyeball back round, or, weaken the muscles to reduce pressure on the eyeball.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A LARGE TABLE, OR A COMPUTER

Not Applicable

### PROGRAM LISTING APPENDIX ON READ-ONLY OPTICAL DISK

Not Applicable

### BACKGROUND OF THE INVENTION

In the past, till now, there has been no good way to heal bad vision. If someone was nearsighted or farsighted, they have had to wear optical lenses with magnification in the form of glasses or contacts. Surgery has also been an optional treatment that reshaped the lens of the eye, but never fixing the shape of the eyeball itself which is commonly known in practice to be the root of the problem. So, a method of healing this condition is very needed as everyday people are chained to their lenses to be able to see clearly.

The same is true with Glaucoma, there has not been a way to reverse this. It is currently the number two cause of blindness in the world. Glaucoma has many causes and does not have any one size fits all treatment, but there is a definite need to help reduce the pressure caused by glaucoma to help prevent blindness.

### SUMMERY OF INVENTION

These are glasses that encourage equal strength of the muscles on all sides of the eyeball. By encouraging equal muscle tension on all sides of the eyeball, the muscles around the eyeball naturally squeeze the eyeball back round and encourages healing one from nearsightedness or farsightedness. These glasses can also be arranged to evenly degrade muscles all around the eyeball to reduce pressure and reduce symptoms of glaucoma in some cases.

### BRIEF DESCRIPTION OF THE SEVERAL VIEWS OF THE DRAWING

FIG. 1 shows the shape of an eyeball with each normal vision, nearsightedness, and farsightedness respectively.

FIG. 2 shows a group of views of the invented apparatus; namely the top, front, bottom, side, and isometric views with the lens(es) (Ref 1) calibrated to encourage healing of nearsightedness (Ref 2).

FIG. 3 shows a group of views of the invented apparatus; namely the top, front, bottom, side, and isometric views with the lens(es) (Ref 1) calibrated to encourage healing of farsightedness (Ref 3).

FIG. 4 shows a group of views of the invented apparatus; namely the top, front, bottom, side, and isometric views with the lens(es) (Ref 1) calibrated to encourage reduction of symptoms of glaucoma (Ref 5).

### DETAILED DESCRIPTION OF THE INVENTION

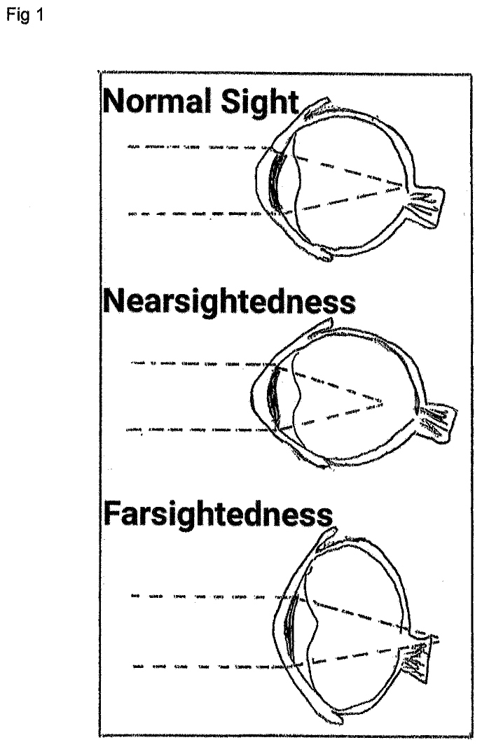

These Are Glasses that encourage the healing of nearsightedness or farsightedness in the eye so that magnification is no longer required by the wearer. I have discovered what causes both nearsighted and farsighted vision. It is posture. Some people look up and down with their eyes and left and right with their head most often. While others look left and right with their eyes and up and down with their head most often. Because of this, the muscle of the movement of the eyeball that a particular person uses most often is stronger in that direction; therefore, that stronger muscle squeezes the eyeball more in that direction. Picture a balloon squeezed about it's equator. The squeezed equator gets narrower and the perpendicular axis gets taller just like the eyes in FIG. 1, where as the narrower side of the eye in abnormal vision is caused by the muscle in that direction being stronger due to higher usage comparatively to the other muscle movements.

So if the weaker muscles in the eye were strengthened so that the muscles squeezed equally all the way around the eyeball, then the equal tension would squeeze the eyeball back round. However, our posture is deeply engrained into habit and difficult to change. So, by will power alone, bad vision is difficult to change. With some types of job's, required physical activity, or personal physical restraints; correcting this may be close to unattainable for many people.

So I found a way to fix this by making custom eyeglasses with a transparent vision correcting strip. They use a normal glasses frame (ref. 4). These glasses are transparent only where the weaker muscle movements of the eyeball position the pupil to see, so they force the eyeballs to only use the weaker movement of the eyeball: Thus, the head must be turned to visually navigate in the other axis, forcing the wearer to use the weaker movement of the eyeball more often to encourage muscle growth. This is needed in order to equalize the muscle tension around the eyeball; therefore, allowing muscle tension to pull the eyeball back round, and thus correcting bad vision. These glasses can be made in many ways as long as they visually hinder the light image to the pupil when using muscles around the stronger axis of the eyeball. They can have transparent lens(es), with the areas around the transparent strip etched into said transparent lens(es), or sprayed over said transparent lens(es). Also, non-transparent opaque lens(es) with a slot formed physically through said lens(es) to act as the transparent strip(s) to look through (ref 1) may also be used to achieve the same results. They can be 3D printed, mold injected, stamped, cast, etc. They can be mirrored like sunglasses, clear like safety glasses, with or without magnification, or even programmed into a liquid crystal display, an augmented reality headset, a virtual reality headset, or any other kind of apparatus worn over the eyes that only allows full transparency of light to the pupil when using the muscles around the axis of the eyeball you wish to strengthen. In addition, also hindering transparency of light to the pupil along the axis of the eyeball that you want to weaken.

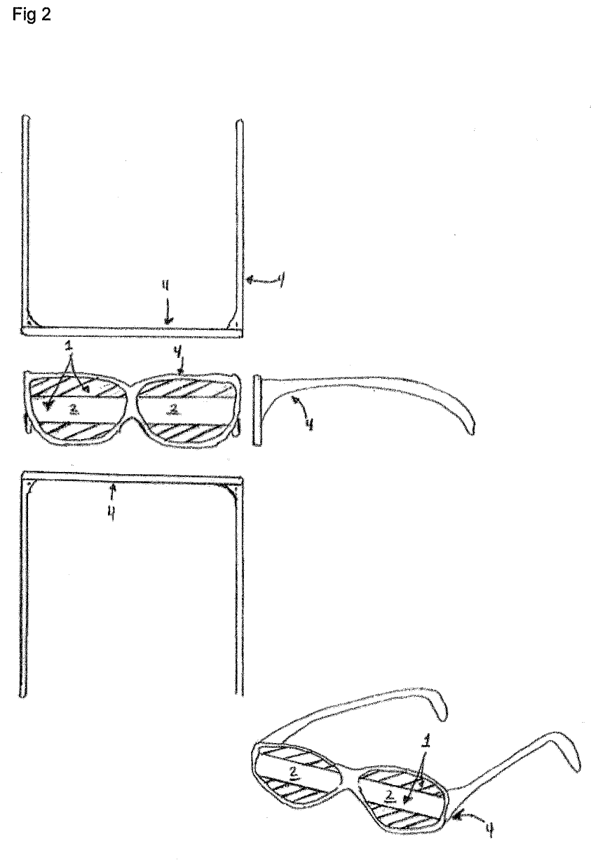

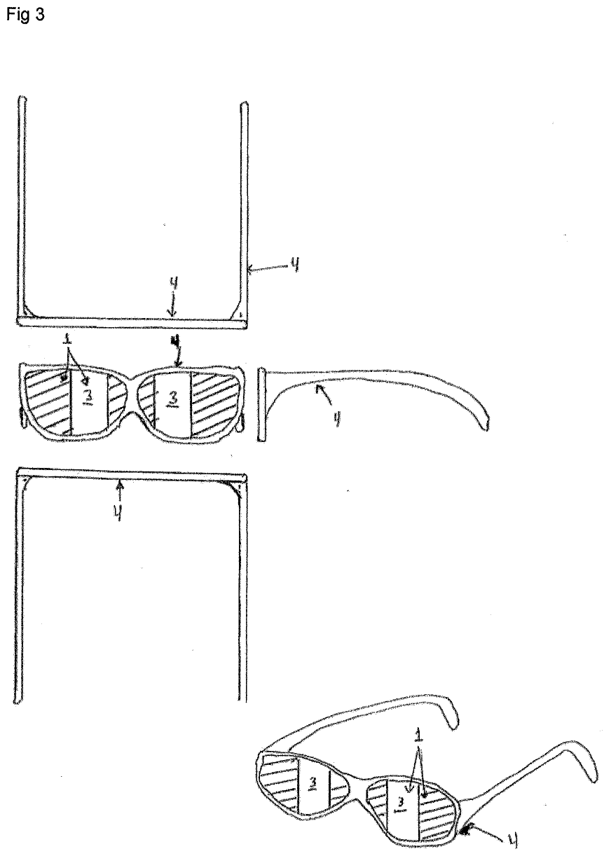

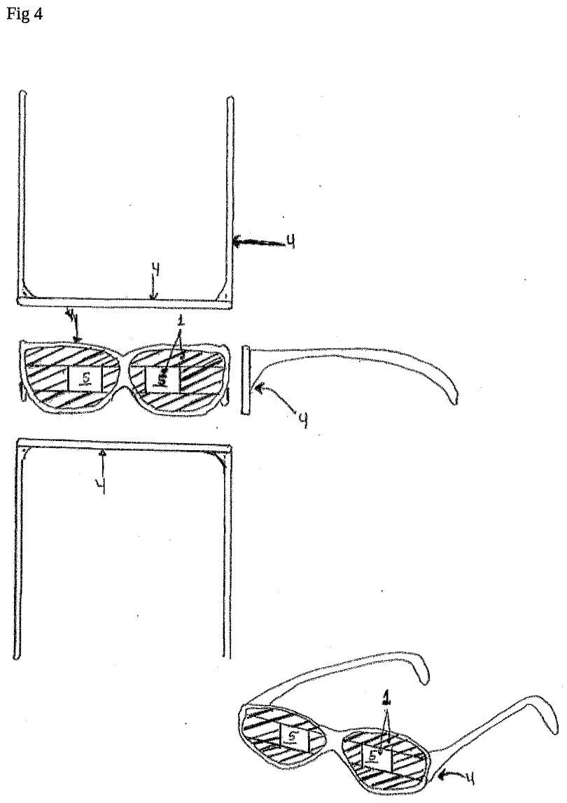

So, if a person is nearsighted, by wearing a pair of these glasses with horizontal transparent strip(s) (FIG. 2, Ref 2), they can heal their eyes back to normal healthy vision. Likewise, if a person is farsighted, by wearing a pair of these glasses with a vertical transparent strip(s) (FIG. 3 Ref 3), they can heal their eyes back to normal healthy vision. And lastly, if a person has glaucoma, they can reduce symptoms by wearing a pair of these glasses with both the transparent strips from before overlapped in such a way that if that person looks left, right, up, or down, the light image to the pupil is hindered. However, if they look straight ahead with their eyes then that part of the lens(es) is transparent (FIG. 4 Ref 5). In this way, that person must turn their head to look around; allowing the muscles around their eyeball to rest, and also allowing those muscles around the eyeball to degrade and weaken. This results in weaker muscle tension around the eyeball, and thus, a reduction of pressure in the eyeball.

1. An apparatus for encouraging the healing of nearsightedness, farsightedness, and some forms of glaucoma, comprising;
a frame, and at least 1 lens(es) that has transparent strip(s) to look through with the remaining part of the lens(es) not being transparent so that the wearer can only obtain a clear picture when they turn their eyeballs so that their pupils face the transparent strip.

2. The apparatus from claim 1, wherein the part of the lens(es) from claim 1 that is not transparent strip(s) can either be completely opaque or translucent to allow the wearer to see blurred motion.

3. The apparatus from claim 1, wherein the transparent strip(s) can be horizontal, vertical, or both across the lens(es) depending on what muscle group around the eyeball that the wearer wishes to strengthen or weaken.

4. The apparatus from claim 1, wherein the length of the transparent strip(s) can be different to obtain different results.

5. The apparatus from claim 1, wherein the lens(es) can be tinted or mirrored to appear like sun shades.

6. The apparatus from claim 1, wherein the lens(es) can be with or without optical magnification so that wearer has the option to use magnification while wearing said apparatus.

7. The apparatus from claim 1, wherein the transparent strip(s) can be programmed virtually into a liquid crystal display, an augmented reality headset, or virtual reality headset to allow the wearer to see through virtual transparent strip(s) electronically.
